(19) United States
(12) Patent Application Publication
(10) Pub. No.: US 2024/0335341 A1
(43) Pub. Date: Oct. 10, 2024

(54) MOBILITY APPARATUS

(71) Applicant: DEKA Products Limited Partnership, Manchester, NH (US)

(72) Inventors: Theresa L. THOMPSON, Manchester, NH (US); Otis L. CLAPP, Epping, NH (US); Thomas A. DOYON, Manchester, NH (US)

(21) Appl. No.: 18/627,720

(22) Filed: Apr. 5, 2024

Related U.S. Application Data
(60) Provisional application No. 63/494,882, filed on Apr. 7, 2023.

(51) Int. Cl. A61G 5/10; A61G 5/12

(52) U.S. Cl. CPC A61G 5/1059; A61G 5/10; A61G 5/128

(57) ABSTRACT

An embodiment of a mobility apparatus configured according to principles of the invention includes a set of plates and fasteners that provide for mounting of a seat at different positions that cause the seat to assume different heights and angles relative to the surface on which the mobility apparatus is. An embodiment of a mobility apparatus configured according to principles of the invention includes a detachable handle that can provide benefits while extended and can be stowed when not in use.

### CROSS REFERENCE TO RELATED APPLICATION(S)

This patent application claims the benefit of U.S. Provisional Patent Application Ser. No. 63/494,882, filed on Apr. 7, 2023.

### RESERVATION OF COPYRIGHTS

Portions of the disclosure of this document contain material that is subject to copyright protection. The copyright owner has no objection to any reproduction of the document or disclosure as it appears in official records, but reserves all remaining rights under copyright.

### BACKGROUND OF THE INVENTION

This disclosure pertains to mobility devices or wheelchairs, and more particularly to adjustments that increase a user's comfort and accessories that increase an assistant's ability to assist.

Wheelchairs, particularly motorized ones, satisfy many functional wants and safety requirements that give users greater access to the world. Nevertheless, user comfort remains in need of improvement. For example, while users' heights vary considerably, the position of the seat remains essentially fixed relative to the floor and the standardized heights of fixtures, such as counters and sinks. For taller users, this means that their knees may be too high for the seat, which discourages distribution of the user's weight across the user's thighs with discomfort and potentially sores developing where the user's weight becomes concentrated. For shorter users, the fixed position of the seat positions them too low for comfortable use, e.g. of a sink, which may cause strain. What is needed is the ability to adjust the height of a seat of a mobility device to better serve users' individual comfort needs.

Patient sizing also makes positioning of the seat relative to the seat back significant to the aforementioned comfort and health concerns. Seats tend to be contoured to conform to typical body configurations, specifically the musculature of the gluteous maximus and biceps femoris. Therefore, a most comfortable and healthy seating position on such contoured seat is where the user's musculature generally corresponds to portions of the seat intended for those anatomical structures. Sitting on the seat other than in this intended design position causes discomfort and potential ulceration issues because the mismatched anatomical and seat features define areas of greater/lesser weight concentrations. What is needed is the ability to adjust the position of the seat relative to the back of a mobility device to better serve users' individual comfort needs.

While seat height is important, dump angle, the altitude of the seat relative to the gravitational normal, also matters greatly to weight distribution and/or user comfort and health. For the same seat angle position, the shape of the lower body musculature, namely the gluteous maximus and biceps femoris, of one user may urge the user into reclining whereas the shape of another may urge the user into inclining, neither bias being comfortable for the user. What is needed is the ability to adjust the angle of a mobility device to better serve users' individual comfort needs.

Sometimes users want or need assistance in the operation of a mobility apparatus. Assistance can be provided by interaction with an attendant handle. A useful handle may protrude from the device to which it is attached to provide leverage. However, such protrusions may undesirably increase the dimensions of the device, increase the risk of damage to the handle, and affect aesthetics. What is needed is a stowable handle can provide benefits while extended and can be stowed when not in use.

### SUMMARY OF THE INVENTION

An embodiment of a mobility apparatus configured according to principles of the invention includes a set of plates and fasteners that provide for mounting of a seat at different positions that cause the seat to assume different heights relative to the surface on which the mobility apparatus is.

An embodiment of a mobility apparatus configured according to principles of the invention includes a set of plates and fasteners that provide for mounting of a seat at different angles that cause the seat to assume different angles relative to the surface on which the mobility apparatus is.

An embodiment of a mobility apparatus configured according to principles of the invention includes a detachable handle that can provide benefits while extended and can be stowed when not in use.

### BRIEF DESCRIPTION OF DRAWINGS

Non-limiting and non-exhaustive aspects of the subject disclosure are described with reference to the following figures, wherein like reference numerals refer to like parts throughout the various views unless otherwise specified.

FIG. 1 is an environmental left side view of an embodiment of a mobility apparatus;

FIG. 2 is a left side elevational view of an embodiment of a mobility apparatus configured according to principles of the invention;

FIG. 3 is a top, front, left side elevational view of an embodiment of a seat interface configured according to principles of the invention;

FIG. 4 is an environmental left side view of an embodiment of a mobility apparatus configured according to principles of the invention;

FIG. 5 is a right side elevational view of the embodiment of FIG. 3;

FIGS. 6A-6C are diagrammatic views of a mobility apparatus configured according to principles of the invention defining different dump angles;

FIGS. 7A-7B are environmental left side views of an embodiment of a mobility apparatus configured according to principles of the invention defining different dump angles;

FIGS. 9A-9B are top, rear, right side elevational views of a frame and stowable handle configured according to principles of the invention; and

FIG. 10 is an image of an embodiment of a mobility apparatus including a stowable handle configured according to principles of the invention in use.

### DETAILED DESCRIPTION OF THE INVENTION

The examples shown in drawings are presented only to demonstrate certain examples of the disclosure. And, the drawings are merely illustrative and are non-limiting. In the drawings, for illustrative purposes, the size of some of the elements may be exaggerated and not drawn to a particular scale. Additionally, elements shown within the drawings that have the same numbers may be identical elements or may be similar elements, depending on the context.

Where the term “comprising” is used in the present description and claims, it does not exclude other elements or steps. Where an indefinite or definite article is used when referring to a singular noun, e.g., “a”, “an”, or “the”, this includes a plural of that noun unless something otherwise is specifically stated. Hence, the term “comprising” should not be interpreted as being restricted to the items listed thereafter; it does not exclude other elements or steps, and so the scope of the expression “a device comprising items A and B” should not be limited to devices consisting only of components A and B. Furthermore, to the extent that the terms “includes”, “has”, “possesses”, and the like are used in the present description and claims, such terms are intended to be inclusive in a manner similar to the term “comprising,” as “comprising” is interpreted when employed as a transitional word in a claim.

Furthermore, the terms “first”, “second”, “third”, and the like, whether used in the description or in the claims, are provided to distinguish between similar elements and not necessarily to describe a sequential or chronological order. It is to be understood that the terms so used are interchangeable under appropriate circumstances (unless clearly disclosed otherwise) and that the aspects of the disclosure described herein are capable of operation in other sequences and/or arrangements than are described or illustrated herein.

In the following description, numerous specific details are set forth to provide a thorough understanding of various aspects and arrangements. It will be recognized, however, that the techniques described herein can be practiced without one or more of the specific details, or with other methods, components, materials, etc. In other instances, well known structures, materials, or operations may not be shown or described in detail to avoid obscuring certain aspects.

Reference throughout this specification to “an aspect,” “an arrangement,” “a configuration,” or “an example” indicates that a particular feature, structure, or characteristic is described. Thus, appearances of phrases such as “in one aspect,” “in one arrangement,” “in a configuration,” “in some examples,” or the like in various places throughout this specification do not necessarily each refer to the same aspect, feature, configuration, example, or arrangement. Furthermore, the particular features, structures, and/or characteristics described may be combined in any suitable manner.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. Moreover, articles “a” and “an” as used in the subject disclosure and claims should generally be construed to mean “one or more” unless specified otherwise or clear from context to be directed to a singular form.

The words “exemplary” and/or “demonstrative,” to the extent used herein, mean serving as an example, instance, or illustration. For the avoidance of doubt, the subject matter disclosed herein is not limited by disclosed examples. In addition, any aspect or design described herein as “exemplary” and/or “demonstrative” is not necessarily to be construed as preferred or advantageous over other aspects or designs, nor is it meant to preclude equivalent exemplary structures and techniques. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, application data, implicit data, explicit data, etc. Inference can be employed to identify a specific context or action or can generate a probability distribution over states of interest based on a consideration of data and events, for example.

The invention is a mobility apparatus that provides greater comfort and ability to provide aid to a user.

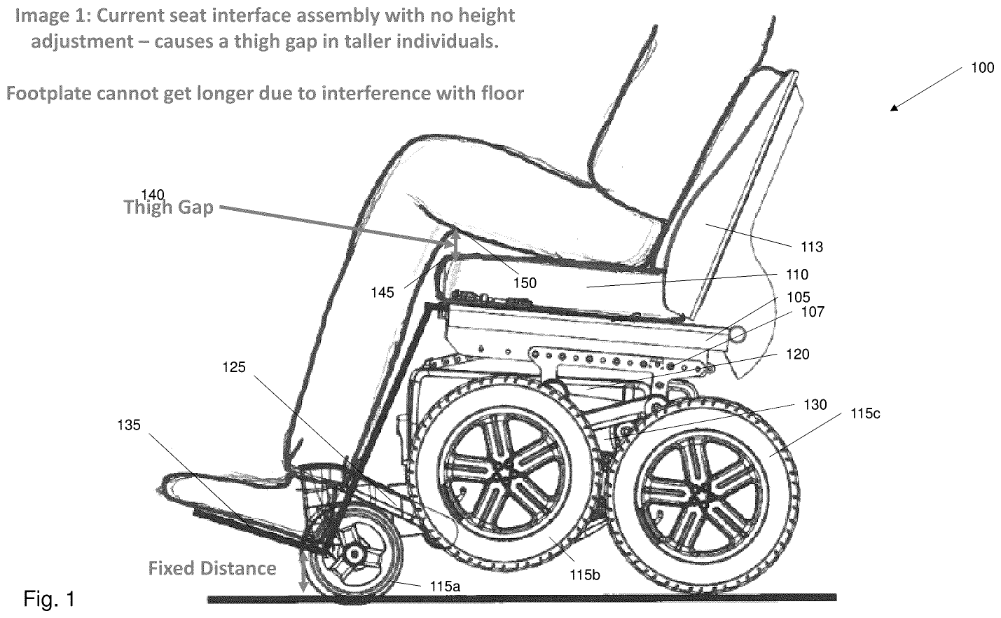

Referring to FIG. 1 an embodiment of a mobility apparatus 100 configured according to principles of the invention is based on the mobility device disclosed in U.S. Patent Application Publication No. US 2021/0276540 ('540 publication), published on Sep. 9, 2021, the disclosure of which is incorporated by reference. Mobility apparatus 100 includes a seat frame 105 that supports a seat 110. Left and right brackets 107 connect seat frame 105 with a power base 120. Power base 120 includes drive and power source components (not shown) for moving mobility apparatus 100 as described in the '540 publication. Ground engaging wheels 115a-c are rotatingly mounted on a power base 120 via a wheel cluster assembly 130 and articulable arms 125 as described in the '540 publication. A footplate 135 is fixed relative to seat frame 105.

While the basic functionalities of mobility apparatus 100 are fairly universal to intended users, basic accommodations are not. For example, as shown in FIG. 1, a tall user seated on seat 110 of mobility apparatus 100 experiences a gap 140 between a leading edge 145 of seat 110 and an intended contact point 150 of the user's thigh. This causes concentration of the user's weight over a smaller area of the user's body on seat 110, which quickly becomes uncomfortable and could lead to important health consequences, such as pressure ulcers or bed sores.

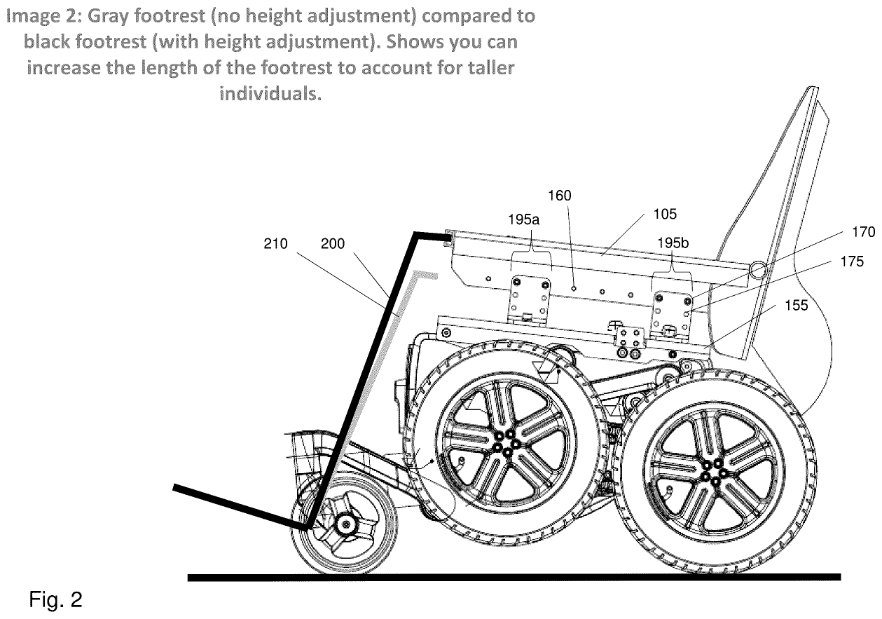

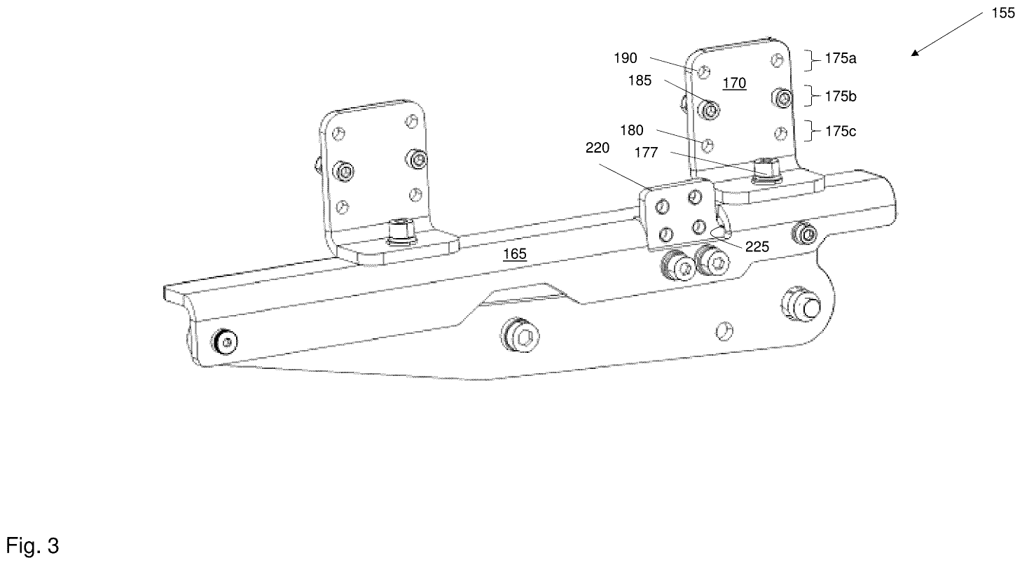

Referring to FIGS. 2 and 3, an embodiment of the invention overcomes the foregoing limitations by providing for vertical adjustability of the seat 110 relative to the power base 120. To this end, the invention replaces brackets 107 with sets of seat interfaces 155 that mount on power base 120. Each seat interface 155 includes a rail 165 to which one or more brackets 170 are connected. Brackets 170 may be mounted with threaded fasteners 177, as shown, or other suitable fastening convention.

Brackets 170 provide a plurality of mounting levels 175 at which seat frame 105 may be mounted. To this end, each mounting level 175 provides for attachment of seat frame 105, preferably via one or more threaded fasteners 185 received through throughbores 190. The desired mounting level 175 is oriented relative to seat frame 105 so that throughbores 190 come into registry with a preferred selection 195 of threaded bores 160 in seat frame 105. Uniform spacing of threaded bores 160 permits selecting a selection 195 at different positions along seat frame 105 so that a position of seat 110 may be altered relative to a back 113 of mobility apparatus 100, as shown in FIG. 1.

An alternative embodiment of the invention includes brackets 170 with vertically-oriented slots (not shown) or other means to provide for non-discrete vertical adjustment of seat frame 105 relative to seat interface 155.

An alternative embodiment of the invention includes a seat frame 105 having a horizontally-oriented slot or other means to provide for non-discrete horizontal adjustment of seat frame 105 relative to seat interface 155.

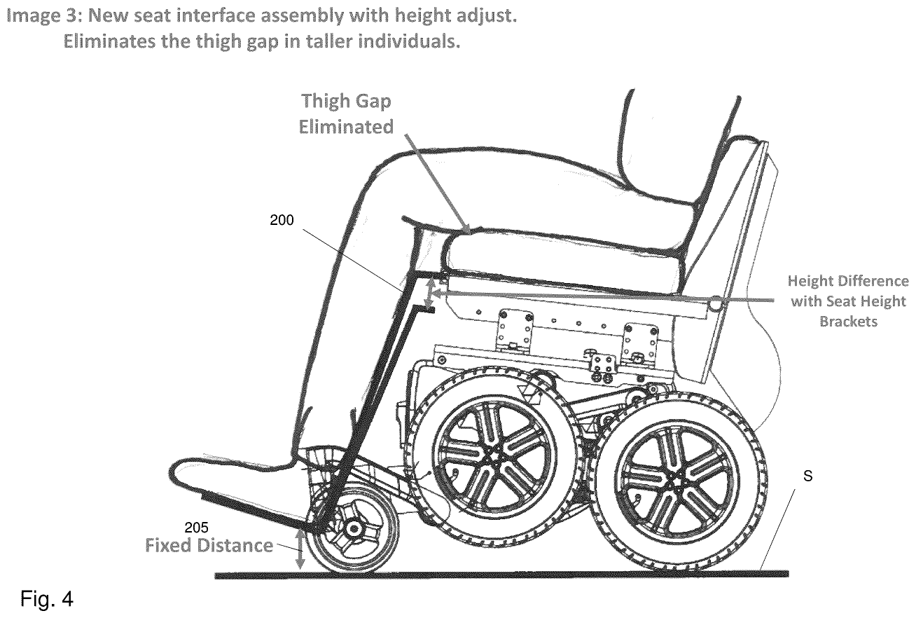

Referring to FIGS. 2 and 4, a preferred embodiment of the invention includes an elongated or extensible footrest 200 that is mounted on seat frame 105. As shown in FIG. 4, footrest 200 maintains the maximum permissible distance 205 between footrest 200 and a surface S on which mobility apparatus 100 exists, and affords more room or length to accommodate a taller user's legs without forming gap 140. Rather than a longer or extensible foot rest 200, an alternative embodiment of the invention provides for attaching a fixed-length footrest 210 to different attachment areas that are fixed relative to seat frame 105.

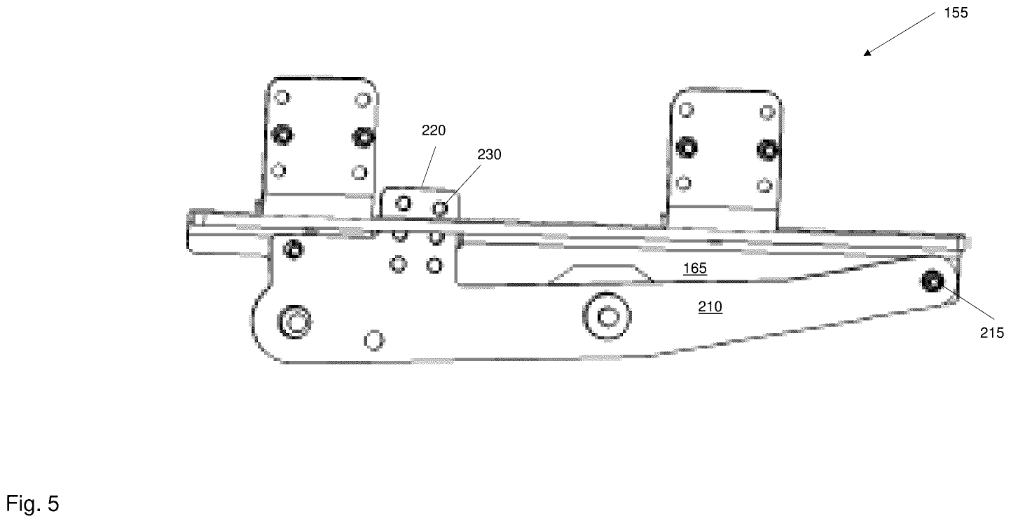

Referring to FIGS. 3 and 5, an embodiment of the invention configured according to principles of the invention provides for dump angle adjustment. To this end, seat interface 155 has an arm 212 that mounts on power base 120 and is pivotally mounted on rail 165 about a bolt 215. Arm 212 has a tongue 220 that is received and passes through an aperture 225 in rail 165. Rail 165 and arm 212 may be pivoted so as to register throughbores (not shown) in rail 165 with threaded bores 230 in tongue 220. Threaded fasteners 230 pass through throughbores (not shown) in rail 165 and are received and threadingly engage with threaded bores 230 in tongue 220, thereby fixing relative positioning of rail 165 and arm 212.

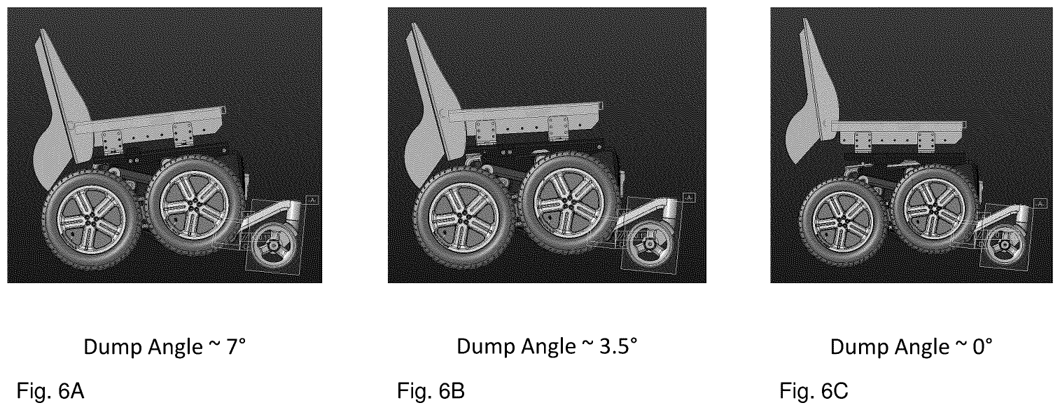

Referring to FIGS. 6A-6C, pivoting rail 165 and arm 212 and registering sets of threaded bores 230 with selected sets of throughbores (not shown) permits selecting different dump angles, preferably ranging from and including roughly 7° to 0° relative to power base 120 and ground level.

An alternative embodiment of the invention includes a tongue 220 having a vertically-oriented slot or other means to provide for non-discrete pivoting of rail 165 and arm 212, hence non-discrete dump angle adjustment.

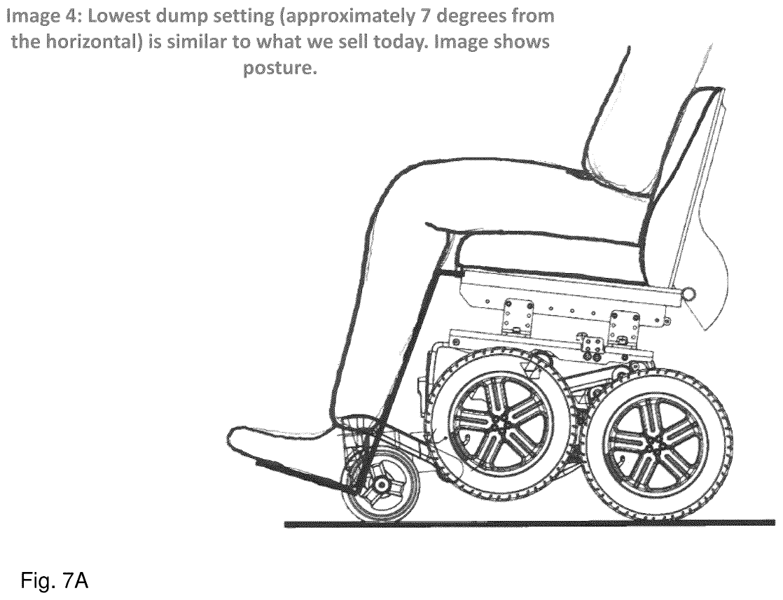

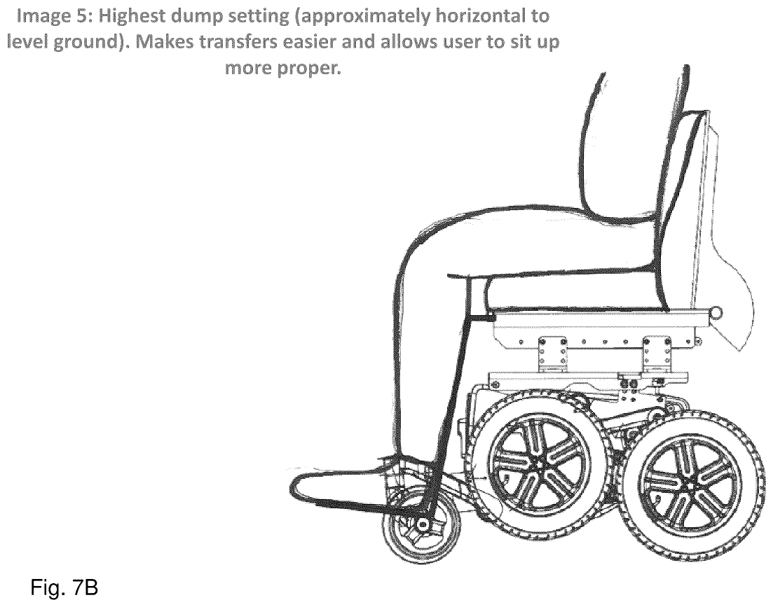

FIGS. 7A and 7B show the differences in posture gained by a user from adjusting the dump angle according to principles of the invention. For example, FIG. 8 shows how the higher dump angle provided by the invention enables the user to sit up more, which also enables greater ease with ingress and egress.

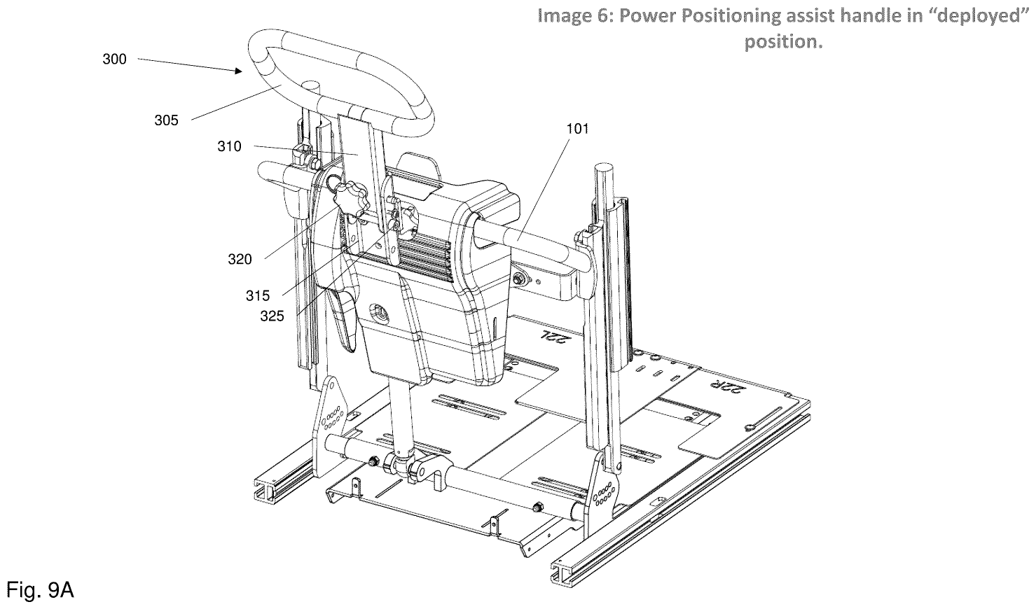

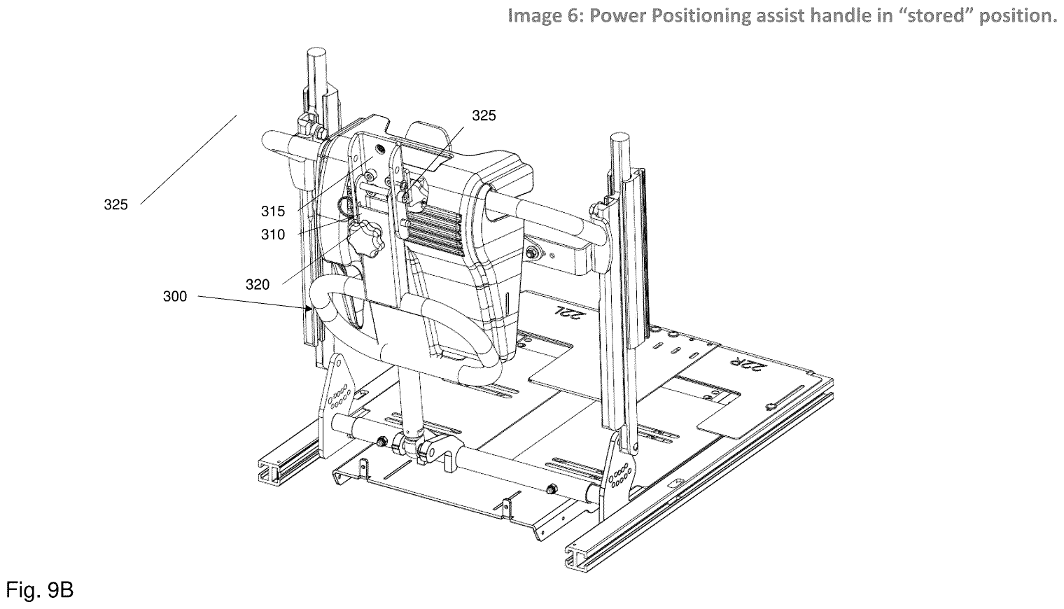

Referring to FIG. 9A, an embodiment of a mobility apparatus configured according to principles of the invention provides a stowable handle 300 can provide benefits while extended and can be stowed when not in use. Handle 300 includes a graspable ring 305 mounted on a stem 310. A bracket 315 having a threaded bore (not shown) is mounted on a frame 101 of the mobile apparatus 100. Stem 310 and bracket 315 have throughbores (not shown) that, when in registry, receive a fastener 325 for pivotally connecting stem 310 and bracket 315. Stem 310 has another throughbore (not shown) located between handle 305 and the pivot at fastener 325 that, when stem 310 is pivoted against bracket 315 as shown in FIG. 9, comes into registry with a threaded bore 330 (FIG. 9B) in bracket 315. A mounting fastener 320 is received in the throughbore (not shown) of stem 310 and threadingly engages threaded bore (not shown) in bracket 315, thereby fixing stem 310 relative to bracket 315.

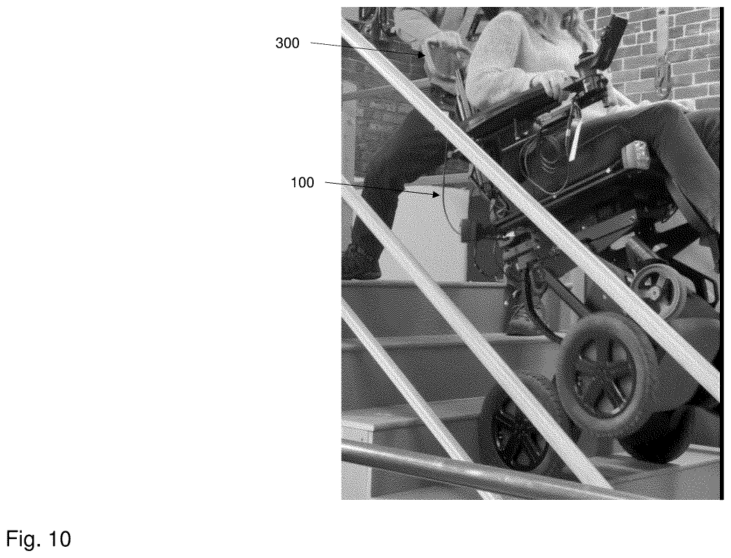

Referring to FIG. 10, handle 300, as configured in FIG. 9, permits assistance with navigating mobile apparatus 100, such as on stairs.

Referring to FIG. 9B, handle 300 is stowable when not in use. Mounting fastener 320 is disengaged from bracket 315 and stem 310. Stem 310 is pivoted about fastener 325 into stowed position as shown in FIG. 11. The throughbore (not shown) of stem 310 comes into registry with a second threaded bore (not shown) in bracket 315. Mounting fastener 320 is received in the throughbore (not shown) of stem 310 and threadingly engages the second threaded bore (not shown) in bracket 315, thereby fixing stem 310 relative to bracket 315.

We claim:

1. Seat interface for a mobility apparatus comprising a bracket configured for affixing relative to a base and having a throughbore configured for registering with a bore in a seat frame.

2. Seat interface of claim 1 wherein said throughbore defines a slot having a major axis that is not aligned with the base.

3. Seat interface of claim 1 wherein said throughbore defines a slot having a minor axis that is not aligned with the base.

4. Seat interface of claim 1, wherein said throughbore defines a distance relative to the base, further comprising a second throughbore that defines a second distance relative to the base.

5. Seat interface of claim 4 wherein said throughbore and/or said second throughbore defines a slot having a minor axis that is not aligned with the base.

6. Mobility device comprising:
the seat interface of claim 1; and
a footrest configured for affixing relative to the base.

7. Seat interface of claim 1 further comprising:
a rail interposed between said bracket and the base; and
a tongue configured for affixing relative to the base and having a second throughbore configured for registering with a second bore in said rail.

8. Seat interface of claim 7 wherein said throughbore defines a slot having a major axis that is not aligned with the rail.

9. Seat interface of claim 7 wherein said throughbore defines a slot having a minor axis that is not aligned with the rail.

10. Seat interface of claim 7, wherein said throughbore defines a distance relative to the rail, further comprising a second throughbore that defines a second distance relative to the rail.

11. Seat interface of claim 10 wherein said throughbore and/or said second throughbore defines a slot having a minor axis that is not aligned with the rail.

12. Seat interface of claim 7 wherein said rail has an end configured for pivoting relative to said tongue.

13. Seat interface of claim 7 wherein said second throughbore defines a slot having a major axis that is not aligned with the base.

14. Seat interface of claim 7, wherein said second throughbore defines a distance relative to the base, further comprising a third throughbore that defines a third distance relative to the base.

15. Seat interface of claim 14 wherein said throughbore and/or said second throughbore defines a slot having a minor axis that is not aligned with the base.

16. Handle for mobility device comprising a member configured for grasping and pivoting relative to the mobility device.

17. Handle of claim 16 further comprising a bracket interposed between said member and the mobility device;
wherein said member and said bracket are configured for receiving and pivoting about a fastener.

18. Handle of claim 16, wherein said member is pivotable from and including a first position and a second position, further comprising a fastener configured for maintaining said member in the first position and/or the second position.

19. Handle of claim 18, wherein said bracket is configured for threaded engagement with said fastener.
